(19) United States
(12) Patent Application Publication
(10) Pub. No.: US 2013/0046761 A1
(43) Pub. Date: Feb. 21, 2013

(54) Method and Apparatus for Social Tagging of Media Files

(71) Applicants: Joakim Söderberg, Solna (SE); Jonas Björk, Stockholm (SE); Apostolos Georgakis, Stockholm (SE)

(72) Inventors: Joakim Söderberg, Solna (SE); Jonas Björk, Stockholm (SE); Apostolos Georgakis, Stockholm (SE)

(73) Assignee: TELEFONAKTIEBOLAGET L M ERICSSON (PUBL), Stockholm (SE)

(21) Appl. No.: 13/520,211

(22) PCT Filed: Jan. 8, 2010
(86) PCT No.: PCT/SE10/50013

§ 371 Date: Oct. 31, 2012

(51) Int. Cl. G06F 17/30

(52) U.S. Cl. 707/736; 707/E17.01

(57) ABSTRACT

Media tagging is significantly improved by fusing subjective, user-specific tags with collaborative, community based tags. Users share multimedia metadata tags in a network of users, to improve automatic tag generation for personal multimedia collections without compromising media privacy. In one method, a combined set of annotation tags is suggested to a user, for use in annotating a given media file. The combined set includes a first set drawn from a private, user-specific repository, and a second set drawn from a public, shared repository. In each case, determining which tags are suggested involves computing similarities between an attribute vector associated with the media file being tagged and attribute vectors associated with the tags. An attribute vector is a set of values representing given types of contextual metadata. The similarity determinations may be weighted according to user-specific and shared weights, and these weightings can be adapted to reflect user and community preferences.

### FIELD OF THE INVENTION

The present invention relates to media tagging, and particularly relates to a method and apparatus for automatically suggesting media tags to a user.

### BACKGROUND

The last decade has seen explosive growth in the usage of devices capable of capturing multimedia formats (digital photography, video and audio), and that growth has raised a number of usability issues, all primarily related to the issue of sensibly storing, organizing, and retrieving multimedia assets. Unlike textual data, automatic methods for describing, indexing and retrieving multimedia material are more difficult to implement in a meaningful fashion.

There have been efforts to provide for meaningful multimedia searching, such as that shown in U.S. Pat. No. 6,735,583 B1, which teaches a hierarchical vocabulary system that is used to classify and locate units of media content from potentially large digital repositories. These repositories store the underlying digital content and associated metadata, along with the structured vocabularies used to characterize that metadata. As another example, there also have been efforts to provide for the use of metadata processing in the context of network-stored multimedia objects. WO 2006057741 A2, for example, provides a network-based metadata service that is available to users and allows individual users to create or select the metadata vocabularies that are used to search, view, or modify the metadata stored for given multimedia objects.

As a general proposition, building and managing potentially large media repositories, and retrieving particular media of interest, is greatly aided by having human-readable (and meaningful)□ annotation□ tags pinned to or otherwise associated with the underlying media files. For example, it is known to generate□ annotation□ tags for tagging a media file based on automated processing. Annotation tags may be generated for a new photograph, based on processing raw metadata associated with that photograph (time, location, image characteristics, etc.). The annotation tags may be automatically applied to the photo, or suggested to the user, or use at the user□ s discretion. In some instances, the annotation tags are based on a custom vocabulary of terms or descriptors, or based on standard vocabularies, which are adapted over time, for a given user□ s preferences. As another example, EP1876539 A1 describes a system for processing media content, to classify individual media items using entries in a structured vocabulary.

Still other examples of automated tagging include certain functions available for the photo management and sharing service known as FLICKR, which allows users to upload, store, and share photo libraries. It is increasingly popular to include□ geo tagging□ information for photos, which identifies where a given photo was taken. For example, the mobile camera phone application ZONETAG provides for geo tagging of a user□ s captured photographs, and for easy uploading to the user□ s FLICKR account. ZONETAG also provides for automatically applying certain other annotation tags to photographs.

In general, FLICKR stands as one example of the growing interest in collaborative tagging and annotation systems, for photos as well as other resources. See, e.g., Golder, S., and Huberman, B. A.,□ The Structure of Collaborative Tagging Systems,□ Tech. Report, HP Labs, 2005. With FLICKR□ s approach to collaborative tagging, a given user uploads a photo, with tagging information that allows other users to more easily search for and view the photo. Thus, photos of a given geographic location of interest, or photos that are tagged as relating to a particular subject of interest, become more readily accessible to the community of users.

Such ready accessibility, however, is inappropriate with respect to photos or other media that is private to a given user. In many instances, a given user□ s data (and metadata) may need to remain private to that user. WO 3088089 A1 and WO 03058502 A1 provide examples of network-based photo sharing systems, with particular emphases on maintaining data/metadata privacy, and on maintaining user-defined metadata within a network environment.

However, a given user may want the benefit of a collaborative community, with respect to the intelligent generation of annotation tag suggestions, while still maintaining the privacy of the underlying media and metadata. There are known systems that make use of context metadata from the media creation as well as interaction among devices and users, and systems that exploit the regularities in media and metadata created by users that share common spatial, temporal and social context (such as calendar information and contacts) to infer media descriptors. See, e.g., Marlow C., Naaman M., et al., HT06, Tagging Paper, Taxonomy, Flickr, To Read, pp. 31-40, Proc. of the 17th ACM Conf. on Hypertext and Hypermedia, Denmark (2006); and Sarvas, R., Herrarte, E., Wilhelm, A., and Davis, M.,□ Metadata creation system for mobile images,□ In Proc. MobiSys□ 04, ACM Press (2004).

Still, there do not appear to be any known solutions that provide automated tagging of media, based on a dynamic melding of subjective, user-specific data and learned preferences with the data and learned preferences of a collaborative, online community of users. Nor do there appear to be any known solutions that provide such processing with appropriate differentiation and handling of□ subjective□ type tags that are tied to a particular user versus factual type tags that are objectively applicable to all users.

### SUMMARY

According to one aspect of the teachings presented herein, media tagging is significantly improved by fusing subjective, user-specific tagging with collaborative, community-based tagging. In this context, users share multimedia metadata tags in a network of users, to improve automatic tag generation for personal multimedia collections, such as photos.

In one embodiment, a method of electronically generating suggested tags to a user for annotating a given media file includes the advantageous fusing of tag suggestions taken from a user-specific, private tag repository with tag suggestions taken from a shared, public repository of tag suggestions. More particularly, one or more embodiments involve automatically suggesting a combined set of tags that includes a first set of suggested tags, which are taken from an electronically stored private repository of tags that is specific to the user, and a second set of suggested tags, which are taken from an electronically stored public repository of tags that is shared by a community of users. The method further includes outputting the combined set of suggested tags for presentation to the user via an electronic user device, which is being used by the user for tagging the media file, and identifying selected tags from among the suggested tags, as selected by the user for tagging the media file.

Advantageously, the first set of suggested tags is based on determined similarities between media file attributes associated with the media file and corresponding tag attributes associated with individual ones of the tags in the private repository. The second set of suggested tags is obtained from the public repository, based on like processing. In this context, it should be understood that any given media file attribute or tag attribute comprises a value for a defined type of contextual metadata, such that a degree of similarity can be determined between any given media file attribute and any given tag attribute having the same defined type of contextual metadata. In this manner, an appropriately configured digital processor can compute the similarity between the values of media file attributes associated with a given media file and the values of corresponding tag attributes associated with a given tag, in either the private or public repository. The suggested set of annotation tags thus intelligently draws from public and private repositories.

In at least one embodiment, the user device comprises a camera phone or other device having the ability to capture and/or store media files, such as photos, songs, etc. In a particular embodiment, the user device is configured, e.g., via software or firmware, to maintain the private repository of tags in local memory, and to carry out the method of automatically generating media tags based on sending metadata for given media to be tagged to a network node that maintains or has access to the public repository of tags. As such, the user device receives the second set of annotation tags, i.e., those determined based on similarity processing done with respect to the public repository, as a list or other data structure returned from the network node. The user device is further configured to display the combined set of suggested annotation tags, e.g., on a display screen of the device, and to detect which, if any of the suggested tags are selected by the user. Alternatively, the network node stores the private repository and the public repository, and performs similarity determinations for both, based on receiving the media metadata from the user device.

Of course, the present invention is not limited to the above brief summary of features and advantages. Those skilled in the art will recognize additional features and advantages, upon reading the following detailed description and upon viewing the accompanying drawings.

### BRIEF DESCRIPTION OF THE DRAWINGS

FIG. 1 is a logic flow diagram of one embodiment of a method of automatically generating annotation tag suggestions to a user.

FIG. 2 is a simplified block diagram of one embodiment of a user device and a tag server (communicatively linked via a wireless communication network), which may be configured to carry out the method of FIG. 1, and variations thereof.

FIG. 3 is a diagram of one embodiment of data structures for a media profile, a private tag repository, a public tag repository, and a user profile.

FIG. 4 is a detailed block diagram of one embodiment of the user device and tag server.

FIG. 5 is a logic flow diagram of another embodiment of a method of automatically generating annotation tag suggestions to a user.

FIG. 6 is a logic flow diagram of another embodiment of a method of automatically generating annotation tag suggestions to a user.

### DETAILED DESCRIPTION

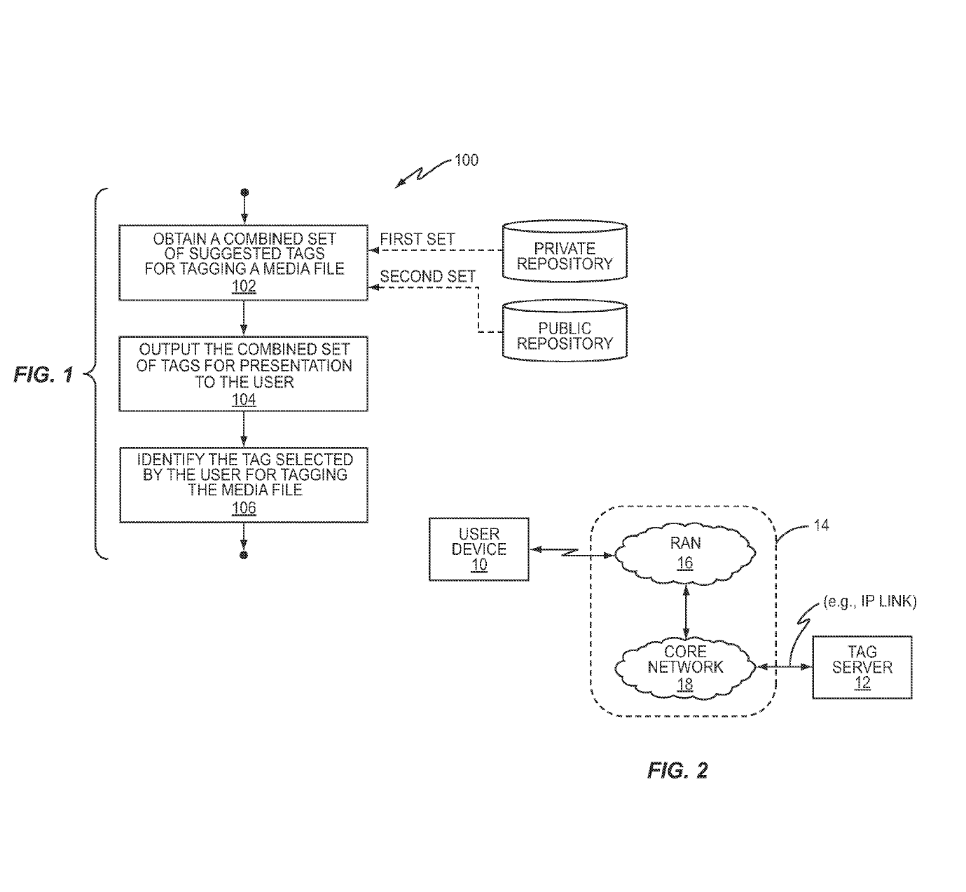

FIG. 1 illustrates one embodiment of a method 100 of electronically generating suggested tags, for use by a user in annotating a media file, e.g., a photo, song, or other media item. Broadly, the method comprises obtaining a combined set of suggested tags, for tagging the media file (Block 102). The first set of suggested tags is taken from an electronically stored private repository of tags that is specific to the user. Conversely, the second set of suggested tags is taken from an electronically stored public repository of tags that is shared by a community of users. Notably, in one or more embodiments, the private repository of tags is adapted or otherwise adjusted according to the tagging behavior of the given user, while the public repository of (community-based) tags is adapted or otherwise adjusted according to the tagging behaviors of a community of users. Thus, the combined set of suggested annotation tags advantageously□ fuses□ private, user-specific tagging information with collaborative, community-driven tagging information.

Continuing with the illustration□ s flow, the method 100 further includes outputting the combined set of tags, for presentation to the user (Block 104) via an electronic user device being used by the user for tagging the media file, and identifying selected tags from among the suggested tags, as selected by the user for tagging the media file (Block 106). As noted, the electronic device may be the user□ s camera phone, media player, or other device having processing, storage, and communication capabilities, as needed to support the processing of the method (100). As such, outputting the suggested tags may comprise outputting them to an LCD or other display included in the electronic device, and identifying the selected tags may comprise detecting, e.g., via key or touch screen presses, which of the displayed tags are selected by the user.

FIG. 2 illustrates an example user device 10, which again may be a camera phone, communication-enabled camera, media player, or the like, shown in conjunction with a tag server 12 that is accessible to the user device 10, for example, via a wireless communication network 14 that includes a Radio Access Network (RAN) 16, and a Core Network (CN) 18. Of course, the user device 10 also may have a wired or other local connection to a communication node, such as a PC with Internet or other communicative access to the tag server 12. As a non-limiting example, the wireless communication network 14 is a cellular communication network, such as a WCDMA- or LTE-based network that provides packet data access to the user device 10. It will also be understood that the tag server 12 may comprise, for example, a computer that is programmed to process metadata, tag data, etc., store and maintain at least the public repository of tags, and to generally provide processing capabilities in accordance with the teachings herein.

With the above in mind, then, one embodiment of the method 100 implements the step of obtaining (Block 102) as the user device 10 obtaining the first set of suggested tags from the private repository as electronically stored within the user device 10, obtaining the second set of suggested tags by sending the media file attributes to a remote network node (e.g., the tag server 12) and receiving the second set of suggested tags in return, and combining the first and second sets of suggested tags. Additionally, the user device 10 sends user preferences to the remote network node, along with sending the media file attributes, to bias the similarity determinations made by the remote network node between the media file attributes and the corresponding tag attributes stored for individual tags in the public repository.

Alternatively, in another embodiment, the method 100 is wholly or at least primarily performed in a network node that is remote from the user device being used by the user for tagging the media file, e.g., in the tag server 12. In this embodiment, the method 100 includes storing the public and private repositories in electronic storage accessible to the network node, receiving the media file attributes from the user device 10, generating the first and second sets of suggested tags and forming the combined set of suggested tags, and outputting the combined set of suggested tags by sending them to the user device 10. Of course, identifying the tag selections made by the user generally requires some form of selection feedback from the user device 10, but the substantive processing for media tagging, and repository updating can be done by the tag server 12. Also, those skilled in the art will appreciate that the tag server 12 may maintain a common public repository for a (potentially large) community of users, while maintaining private repositories for individual users.

In any case, it is a distinctive advantage of the method depicted in FIG. 1 that the first set of suggested tags is based on determined similarities between media file attributes associated with the media file and corresponding tag attributes associated with individual ones of the tags in the private repository, and the second set of suggested tags is likewise obtained from the public repository. Here, any given media file attribute or tag attribute comprises a value for a defined type of contextual metadata, such that a degree of similarity can be determined between any given media file attribute and any given tag attribute having the same defined type of contextual metadata.

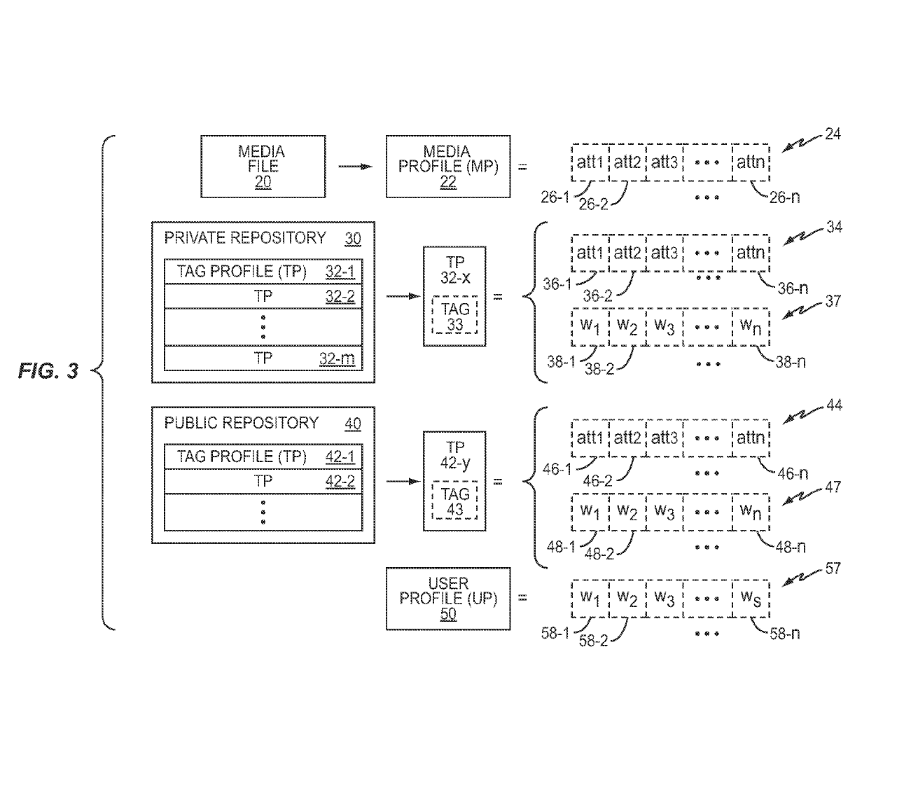

To better understand the method of FIG. 1 and its variations, FIG. 3 provides example illustrations of: (a) a media file 20 and its associated media profile (MP) 22: (b) a private repository 30 comprising tag profiles (TPs) 32, each TP 32 including a tag 33, a set 34 of tag attributes 36, and a set 37 of tag attribute weights 38; (c) a public repository 40 comprising TPs 42, each TP 42 including a tag 43, a set 44 of tag attributes 46, and a set 47 of tag attribute weights 48; and (d) a user profile 50 comprising a set 57 of metadata type weights 58.

In this context, the attributes (26, 36, or 46) are factual metadata. That is, each attribute (26-1, 26-2, □ , 36-1, 36-2, □ , and 46-1, 46-2, □ ) is configured to hold a value for a given type of metadata. Thus, for the MP 22 generated or obtained for a given photograph, song, or other media file 20, the set 24 of media file attributes 26 may be regarded as a vector of metadata attributes containing factual metadata about the media file 20. As an example, a GPS-enabled camera phone captures a digital photograph and/or the camera phone has access to external information sources, such as a calendar and event information. As such, an example set 24 of media file attributes 26 for a captured photograph might include:
attribute 26-1 (att1) holds location type metadata, such as (38°57 33.80, 95°15 55.74) as values for longitude and latitude;
attribute 26-2 (att2) holds time type metadata, such as 18:30:49, to indicate a 24-hr time value;
attribute 26-3 (att3) holds parametric metadata, such as a camera setting;
attribute 26-4 (att4) holds Boolean metadata, such as a flag for □ face detection=yes□ or □ face detection=no□ ; and
attribute 26-5 (att5) holds image characterization data, such as a □ landscape,□ □ outdoors,□ or □ portrait□ label.

Of course, the above attribute definitions are non-limiting examples, and there may be more or fewer attributes defined within the □ system□ described herein, and not all attributes may be used for every media file 20.

Further, there may be a different definitions used for the MPs 22, the TPs 32, and the TPs 42, in dependence on the type of media file 20 that is being processed for tag suggestions□ e.g., different sets or kinds of tags and associated metadata types for photographs versus songs or videos. Alternatively, the sets of metadata embodied in the set 24 of media file attributes (and in the sets 34/44 of the tag attributes 36/46) may cover the full universe of metadata types understood for all types of media files 20 that are of interest. In this case, only those attributes 26 that are meaningful for a given media file 20 may be set and/or processed, and the similarity comparisons between individual ones of the attributes 26 and the tag attributes 36 and/or 46 would be coordinated so that the comparisons are being performed for like types of metadata. In one definition of attributes contemplated herein, att26-i={value} represents the i-th one in the set 24 of media file attributes 26. It may map, in terms of metadata types, to the i-th one of the attributes 36/46 in the set 34/44, or other mappings, e.g., i-to-j, may be used. In any case, the point is to compare like types of metadata.

Further, the tags 33 in the private repository 30 and the tags 43 in the public repository 40 may comprise, for example, text strings representing human-meaningful keywords, labels, or other textual data that is useful for annotating given types of media files 20. Further, the tag attributes 36 for each tag 33 (or tag attributes 46 for each tag 43) hold values for given types of metadata that are associated with the tag 33 (or 43). Thus, when determining whether a given tag 33 or tag 43 should be suggested to a user, the processing contemplated herein can determine whether to suggest a given tag 33 or 43 to a user for tagging a given media file 20, based on determining the similarities between the values of metadata types associated with the media file 20 and the values of the metadata types associated with the tag 33 or 43. That is, given attributes 26 are compared to given attributes 36 (for a tag 33) or to given attributes 46 (for a tag 43). In this regard, it is useful to recognize that some types of metadata are subjective with respect to the given media file 20 at hand, while other types of metadata are subjective to the particular user that is tagging the media file 20. (As will be seen herein, the user profile 50 advantageously captures user subjectivity.)

With the above in mind, a more detailed discussion of FIG. 3 for a given media file 20 begins with the MP 22, which comprises a set 24 of media file attributes 26□ e.g., att1 denoted as 26-1, att2 denoted as 26-2, and so on. Each media file attribute 26-x represents the value of a predefined item or type of metadata that was generated for or otherwise captured in association with the media file 20. For each media file 20, there generally is one defining MP 22, with the media file attributes 26 set to particular values appropriate for describing or characterizing that media file 20.

Note that the metadata generated or captured for a given media file 20 may be very rich, or may be relatively sparse. As such, not all attributes 26 are necessarily set in a given MP 22, nor are all attributes 26 necessarily used in all similarity determinations, as used for generating tag suggestions. Indeed, the set 24 of media file attributes 26 can be understood as a vector of metadata values, where each element of that vector represents a given, defined type of metadata that is understood within the system at hand. For example, the universe of defined metadata types for digital photographs may include a time attribute, a location attribute, a temperature attribute, a group/single photo type attribute, an indoors/outdoors attribute, a face detection and/or face recognition attribute, etc. The defined metadata types for digital song files obviously would be different, although there may be overlapping types.

In this regard, those skilled in the art should understand that the public and private repositories, and the associated tag generation method, can be tailored to one specific type of digital media, e.g., dedicated to photographs, to music, or to videos, or they can be expanded to include metadata types covering a range of media file types, or they can be restricted to metadata types appropriate for a given type of media files. In any case, each attribute 26-x serves as a placeholder for storing the value of a particular type of metadata, as generated for or captured with the associated media file 20. Such values may be numeric, e.g., temperature, time-of-day, location, etc., or may be Boolean, such as □ group portrait?□ , □ recognized face?□ etc. Further, there may be textual (string) attributes, such as a name attribute. It should also be noted that the metadata associated with a given media file 20 may not include the complete set of metadata types understood within the context of the private and public repositories, or may include the full set, with unused or inapplicable attribute types set to default values or flagged as unused.

With that understanding, one sees in FIG. 3 an example illustration of the private repository 30, here comprising a plurality of data structures referred to as tag profiles (TP) 32 (e.g., 32-1, 32-2, and so on). Assuming that □ x□ refers to any particular one of the TPs 32 in the private repository 30, each TP 32-x includes a human-meaningful media annotation tag 33, such as a text string, along with a set 34 of tag attributes 36 and corresponding tag attribute weights 38. Each tag attribute 36-1 (att1), 36-2 (att2), and so on, is configured to hold a value for a given type of metadata. Thus, any given tag attribute 36 can be compared to a corresponding one of the media file attributes 26, for any given MP 22. Here, □ corresponding□means the media file attribute 26 of the same metadata type as the tag attribute 36 under consideration. As a simple example, the media file attribute 26-1 may be a time-of-day value, and the TPs 32 are similarly defined such that their first tag attributes 36-1 are time-of-day values, allowing for similarity comparisons between the media file attribute 26-1 and the tag attribute 36-1 in each of the TPs 32.

Thus, each media file attribute 26 is configured to hold a value for a given defined type of metadata that is useful in describing or characterizing a media file 20. Similarly, each tag attribute 36 corresponds to a particular type of metadata. In at least one embodiment, each MP 22 includes a fixed number of media file attributes that are of known types and in a known order. The same number, types, and ordering are used to define the set 34 of tag attributes for each TP 32, thus allowing a one-to-one mapping/comparison between the media file attributes 26 included in any given MP 22 and the tag attributes 36 included in any given TP 32. (In other embodiments, the order, number, and types of media file attributes 26 are not fixed, but each media file attribute 26 (and tag attribute 36) includes a type identifier, from which the type of metadata represented by it can be electronically read. With this arrangement, the contemplated comparisons between media file attributes 26 and corresponding tag attributes 36 can be carried by identifying like attribute types between the MP 22 and the TP 32 and comparing them.)

Further, as noted, each TP 32 includes a set 37 of tag attribute weights 38, e.g., weight 38-1 denoted as w1, weight 38-2 denoted as w2, and so on. Although other mappings can be used, in one embodiment the tag attribute weight 38-1 holds a weight for use with the tag attribute 36-1, and the tag attribute weight 38-2 holds a weight for use with the tag attribute 36-2, and so on. For any given TP 32 and included tag 33, each weight 38 is adapted according to the selection behavior of the user that □ owns□ with the private repository 30, such that each tag attribute weight 38 reflects how important a given attribute 36 is with respect to the user□ s selection of the tag 33. For example, assume that it is observed that the user selects the tag 33 of TP 32-1 even when there is a low similarity between the values of the tag attribute 36-1 of TP 32-1 and the corresponding media file attribute 26-1 in the MPs 22 of the media files 20 being tagged by the user. In this case, the weight 38-1 may be decreased, to reflect the decreased importance of the tag attribute 36-1.

In general, for each TP 32, each tag attribute 36 has an associated tag weight 38 that indicates how important that tag attribute 36 is to the user□ s historical selection of the annotation tag 33 included in the TP 32. The user□ s propensity to select a given tag 33 may be strongly tied to certain ones of the tag attributes 36 associated with that tag 33/TP 32, but weakly tied to certain others, and the tag weights 38 are adapted over multiple tag selections by the user, to reflect these various preferences.

On also sees in FIG. 3 that the public repository 40 comprises a number of tag profiles (TPs) 42. The TPs 42 in the public repository 40 are generally like those in the private repository 30, e.g., each TP 42-y in the public repository 40 includes an annotation tag and an associated set 44 of tag attributes 46 (46-1 denoted as att1, 46-2 denoted as att2, and so on). Like the TPs 32 in the private repository 30, each TP 42-y includes a set 47 of tag attribute weights 48. Unlike the tag weights 38 in the private repository 30, the tag weights 48 in the public repository 40 are adapted responsive to selections by multiple users in a potentially large community of users. In this regard, the set 47 of weights 48 for a given TP 42 in the public repository 40 reflect how important a given tag attribute 46 is to the selection of the annotation tag included in the given TP 42. As such, the tag weights 38 in the private repository 30 reflect an individual user□ s preferences or selection behavior, while the tag weights 48 in the public repository 40 reflect the preferences or selection behavior of the overall user community (i.e., collaborative weighting).

Finally, in FIG. 3, one sees a user profile 50, which may be electronically stored at the user device 10 and/or at a network node, that includes yet another set 57 of weights 58. Each weight 58-1, 58-2, and so on, represents how important a given type of metadata is to the individual user. For example, assume that user profile weight 58-1 (w1) corresponds to time-of-day metadata. If it is observed over time that the user□ s selections of annotation tags are not strongly driven by time-of-day metadata values, then the value of w1 is reduced. On the other hand, if it appears that tag selections are strongly driven by time-of-day metadata values, the value of w1 is increased.

With the above in mind, one may recollect that method 100 (shown in FIG. 1) included the step of obtaining a combined set of tags 33 and 43, for tagging, a given media file 20. As was explained, the first set of suggested tags is based on determined similarities between media file attributes 26 associated with the media file 20 and corresponding tag attributes 36 associated with individual ones of the tags 33 in the private repository 30. Further, the second set of suggested tags is likewise obtained from the public repository 40□ i.e., the second set of suggested tags is based on determining similarities between the media file attributes 26 associated with the given media file 20 and corresponding tag attributes 46 associated with individual ones of the tags 43 in the public repository 40. As noted, any given media file attribute or tag attribute comprises a value for a defined type of contextual metadata, such that a degree of similarity can be determined between any given media file attribute and any given tag attribute having the same defined type of contextual metadata.

At least one embodiment of the method 100 includes weighting said similarity determinations made with respect to the private repository 30 according to user preferences specific to the user. These user preferences are learned based on past selections of suggested tags made by the user. Further, the similarity determinations made with respect to the public repository 40 also may be weighted according to community preferences global to the community of users. These community preferences are learned based on past selections of suggested tags made by users within the community of users.

In at least one such embodiment, the user preferences comprise a set 37 of tag attribute weights 38 corresponding to the tag attributes 36 associated with each tag 33 stored in the private repository 30. (Each such tag 33 may be carried within a TP 32 that also includes the set 34 of tag attributes 36 and the set 37 of tag attribute weights 38 associated with that tag 33.) The user preferences may further comprise a user profile 50, comprising a set 57 of metadata type weights 58 corresponding to different types of metadata, among the defined types of contextual metadata that are processed in the context of the method 100.

With this arrangement, one or more embodiments of the method 100 include adapting the tag attribute weights 38 for a given tag 33 in the private repository 30 each time the user selects that tag 33 for tagging any given media file 20, based on the similarity of values between each tag attribute 36 and the corresponding media file attribute 26 of the given media file 20, so that the tag attribute weights 38 over time reflect a relative importance attached by the user to each tag attribute 36 of that tag 33. Further, at least one such embodiment of the method 100 includes adapting the user profile 50 for the tags 33 selected by the user for tagging any given media file 20, based on the similarity of values between the media file attributes 26 and the values of the corresponding tag attributes 36 of the selected tags 33, so that the user profile 50 over time reflects a relative importance attached by the user to the different types of contextual metadata. Still further, in at least one such embodiment, the method 100 includes using the user profile 50 to bias the weighting of the similarity determinations made with respect to the public repository 40. (In this manner, the tag suggestions taken from the public repository 40 are biased or otherwise influenced by the individual user□ s preferences and by the aggregate preferences of the user community at large.)

In supporting such functionality, and in keeping with the example of FIG. 3, one or more embodiments of the method 100 include maintaining the private repository 30 as a set of tag profiles 32, each tag profile 32 comprising a tag 33 for annotating media files 20, a set 34 of tag attributes 36, each attribute 36 being a value for one of the defined types of contextual metadata, and a set 37 of tag attribute weights 38 corresponding to the tag attributes 36, and updating each tag attribute weight 38 whenever the user selects the corresponding tag 33 for tagging a given media file 20, based on computing the degree of similarity between the value of the associated tag attribute 36 and the corresponding media file attribute 26 (in the MP 22) of the media file 20 being tagged.

Further, in at least one such embodiment, the method 100 includes maintaining a user profile 50 of metadata type weights 58, each metadata type weight 58 comprising a value for one of the defined types of contextual metadata, and updating a given metadata type weight 58 in the user profile 50 whenever the user selects a suggested tag 33 having a tag attribute 36 of the same type, based on computing the degree of similarity between the value of the tag attribute 36 and the corresponding media file attribute 26 of the media file 20 being tagged.

Still further, in one or more embodiments, the method 100 includes maintaining the public repository 40 as a set of tag profiles 42, each tag profile 42 comprising a tag 43 for annotating media files 20, a set 44 of tag attributes 46, each attribute 46 being a value for one of the defined types of contextual metadata, and a set 47 of tag attribute weights 48 corresponding to the tag attributes 46, and updating each tag attribute weight 48 whenever any given user in the community of users selects the corresponding tag 43 for tagging a given media file 20, based on computing the degree of similarity between the value of the associated tag attribute 46 and the corresponding media file attribute 26 (in the MP 22) of the media file 20 being tagged.

Still further, in at least one embodiment, the method 100 includes maintaining a commercial tag repository along with or within the public tag repository 40, for use in suggesting commercial tags to the community of users. At least one such embodiment includes setting tag attribute weights for any given one of the commercial tags according to a monetary value of the commercial tag. For example, a product, brand, or store owner can, via an electronic transaction, submit payment for a given commercial tag to have that tag included in the combined set of suggested tags (at least when appropriate in view of the metadata associated with the media file 20 being tagged), and/or can pay more to increase the weighting used to determine whether the commercial tag will be included in the combined set of suggested tags.

However, regardless of whether commercial tags are used, one or more embodiments of the method 100 include generating the first set of suggested tags according to selection weights that are specifically adapted based on suggested tag selections made by the user (e.g., the tag attribute weights 38 used to weight tags 33 in the private repository 30), and generating the second set of suggested tags according to selection weights that are adapted according to suggested tag selections made by given ones in the community of users (e.g., the tag attribute weights 48 used to weight tags 43 in the public repository 40).

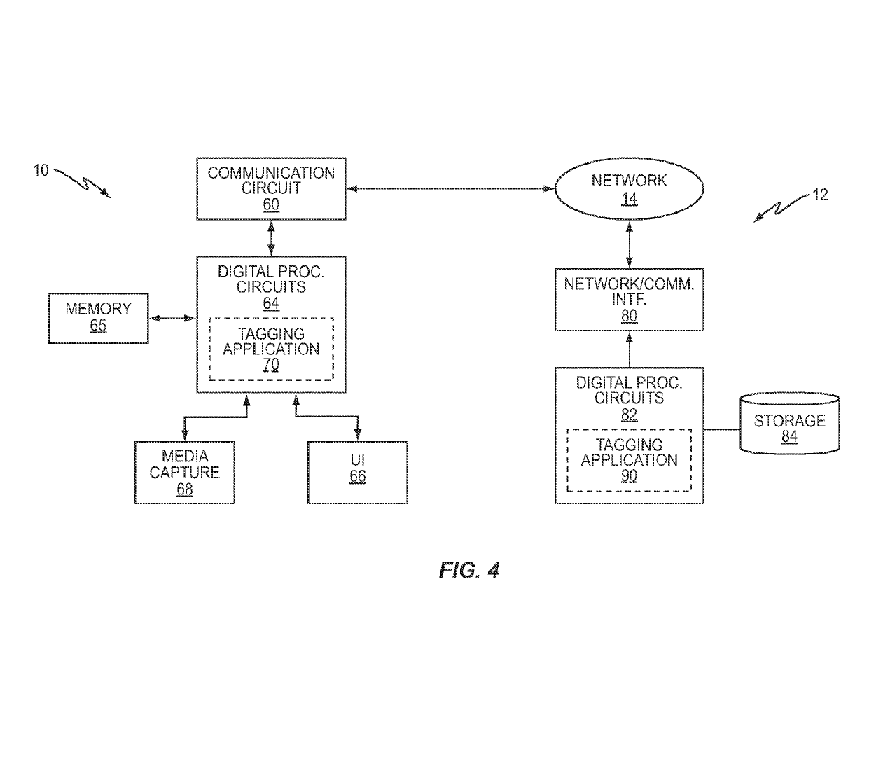

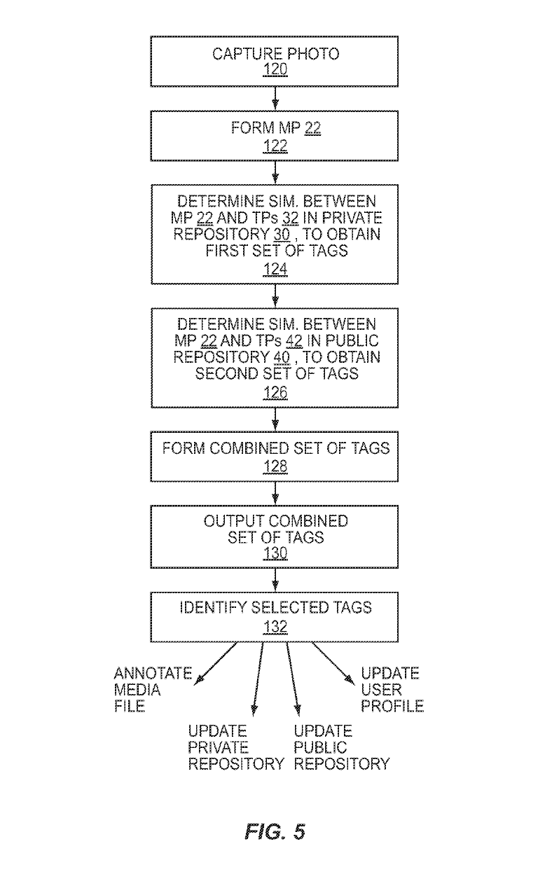

FIG. 4 illustrates an example embodiment of the user device 10, configured as an apparatus 10 for automatically suggesting tags to a user, for annotating a media file 20. The illustrated user device 10 includes a communication circuit 60 for communicating with the network 14□ e.g., the communication circuit 60 comprises a wired and/or wireless communication circuit, such as a cellular radio transceiver. The user device 10 further includes one or more digital processing circuits 64, such as one or more microprocessor-based circuits, memory 65, a user interface (UI) 66, and a media capture device 68 (such as a digital camera). The UI 66 may include a keypad and an LCD screen and/or a touch screen, for displaying tag suggestions to the user and receiving tag selection inputs from the user, to indicate which suggested tags are desired by the user, for use in tagging a given media file 20.

It will be understood that the digital processing circuits 64 of the user device 10 may execute one or more software applications, associated with various functional features of the device 10. One such application includes a tagging application 70 that allows the user to carry out media file tagging as taught herein. The tagging application 70 can be a standalone application that is configured for tagging one or more types of media files 20, which may be stored locally in memory 65, or may be stored remotely in the network 14, such as at the tag server 12. Additionally, or alternatively, the tagging application 70 is configured to run in conjunction with media capture processing, such as when a picture is taken, or when photos are being reviewed.

Regardless, it will be appreciated that the tagging application 70 provides at least some of the functional processing needed to implement the method 100 (and variations thereof), or it at least is configured to provide an interface to such functionality as implemented on the tag server 12, which is also illustrated in FIG. 4. According to the example details, the tag server 12 includes a network/communication interface 80, such as an Internet communication interface for IP-based access to the tag server 12.

Further, the tag server 12 includes one or more digital processing circuits 82 and associated storage 84, which may include digital memory and/or disc storage, and which may store one or more computer programs that, when executed by the digital processing circuits 82, implement a tagging application 90 on the tag server 12. In this regard, the digital processing circuits 82 may comprise a computer or other microprocessor-based circuit, and the tagging application 90 provides some or all of the functional processing needed to implement the method 100.

Thus, the user device 10, the tag server 12, or both working in conjunction, can be understood as comprising an electronic apparatus that includes one or more digital processing circuits configured to: (a) obtain a combined set of suggested annotation tags for a given media file 20, where the combined set includes a first set of suggested tags taken from an electronically stored private repository 30 of tags 33 that is specific to the user and a second set of suggested tags taken from an electronically stored public repository 40 of tags 43 that is shared by a community of users; (b) output the combined set of suggested tags for presentation to the user via an electronic user device being used by the user for tagging the media file 20; and (c) identify selected tags from among the suggested tags, as selected by the user for tagging the media file 20. Here, the first set of suggested tags is based on determined similarities between media file attributes 26 associated with the media file 20 and corresponding tag attributes 36 associated with individual ones of the tags 33 in the private repository 30. The second set of suggested tags is likewise obtained from the public repository 40. Generally, any given media file attribute 26 or tag attribute 36 (or 46) comprises a value for a defined type of contextual metadata, such that a degree of similarity can be determined between any given media file attribute 26 and any given tag attribute 36 or 46 having the same defined type of contextual metadata.

In at least one embodiment, the apparatus comprises the user device 10, where the user device 10 includes memory 65 operatively associated with the one or more digital processing circuits 64, for storing the private repository 30. Further, the communication circuit 60 is operatively associated with the one or more digital processing circuits 64, for communicatively coupling the user device 10 to a remote network node (e.g., the tag server 12) storing the public repository 40. In this embodiment, the user device 10 is configured to obtain the second set of suggested tags by sending the media file attributes 26 (as included in the MP 22 for the given media file 20) to the remote network node and receiving the second set of suggested tags in return.

In such cases, the memory 65 of the user device 10 stores user preferences for tag selection. In one or more such embodiments, the user device 10 is configured to send the user preferences to the remote network node (e.g., the tag server 12), along with the media file attributes 26 (for a given media file 20), to bias the similarity determinations made by the remote network node between the media file attributes 26 and the corresponding tag attributes 46 stored for individual tags 43 in the public repository 40. As noted, the user preferences include, for example, the user profile 50.

In another embodiment, the apparatus comprises a remote network node, such as the tag server 12, that is configured to perform most or all of the substantive processing of the method 100 (i.e., the similarity determinations and weight adaptations). In such an embodiment, the network node is communicatively coupled directly or indirectly to the user device 10, and is configured to: (a) access electronic storage storing the public and private repositories 30 and 40; (b) receive the media file attributes 26 from the user device 10; form the combined set of suggested tags by determining similarities with respect to the private and public repositories 30 and 40□ i.e., the similarities between the media file attributes 26 and corresponding ones of the tag attributes 36 for tags 33 in the private repository 30 and tag attributes 46 for tags 43 in the public repository 40; and output the combined set of suggested tags by sending them to the user device 10.

Further, in at least one embodiment, the digital processing circuits 64 (and/or 82) are configured to weight the similarity determinations made with respect to the private repository according to user preferences specific to the user, where the user preferences are learned based on past selections of suggested tags made by the user. In the same manner, the similarity determinations made with respect to the public repository 40 may be weighted according to community preferences global to the community of users, wherein the community preferences are learned based on past selections of suggested tags made by users within the community of users.

The user preferences may comprise a set 37 of tag attribute weights 38 corresponding to the tag attributes 36 associated with each tag 33 stored in one of TPs 32 within the private repository 30. The user preferences also may include a user profile 50 comprising a set 57 of metadata type weights 58 corresponding to different types among the defined types of contextual metadata. In this regard, the digital processing circuits 64 of the user device 10 and/or the digital processing circuits 82 of the tag server 12 are configured to adapt the tag attribute weights 38 for a given tag 33 in the private repository 30 each time the user selects that tag for tagging any given media file 20. The adapting is based on computing the similarity of values between each tag attribute 36 and the corresponding media file attribute 26 of the given media file 20, so that the tag attribute weights 36 over time reflect a relative importance attached by the user to each tag attribute 36 of that tag 33.

The processing circuits 64 and/or 82 also may be configured to adapt the user profile 50 for the tags 33 and/or 43 that are selected by the user for tagging any given media file 20. Such adapting is based on computing the similarity of values between the media file attributes 26 and the values of the corresponding tag attributes 36 and/or 46 of the selected tags 33 and/or 43. In this manner, the user profile 50 is adapted over time to reflect a relative importance attached by the user to the different types of contextual metadata. Notably, the processing circuits 64 and/or 82 are configured in one or more embodiments to use or otherwise provide the user profile 50, for biasing said weighting of the similarity determinations made with respect to the public repository 40.

FIG. 5 illustrates a practical, non-limiting example of the processing functionality provided by the above-described apparatus configurations. Processing begins with capturing a photo (Block 120). For example, the user device 10 comprises a camera phone and the user takes a digital picture with it. The user device 10 forms an MP 22 for the newly captured digital picture (Block 122). The MP 22 includes contextual metadata values for any number of metadata file attributes 26, where the particular values are determined by, for example, any one or more of a clock circuit that provides capture time, a location (GPS) circuit that determines capture location, a temperature detector that determines outside ambient temperature for the time of capture, etc. Note too, that the tag server 12 can form the MP 22, for any given media file 20, e.g., based on information received from the user device 10, or from wherever the photograph was captured.

In any case, the processing continues with determining similarities between the MP 22 and the TPs 32 in the private repository 30, to obtain the first set of tags (Block 124). Thus, this first set of suggested tags includes those tags 33 identified from the private repository 30, based on the similarity determinations. In turn, these similarity determinations involve the user device 10 and/or the tag server 12 comparing the MP 22 to each of one or more TPs 32 in the private repository 30. Specifically, the comparison involves determining the similarity between the values of the media file attributes 26 and the corresponding ones of the tag attributes 36 that are associated with each TP 32. As an example, similarity determination processing determines the similarity between the MP 22 and the TP 32-1 in the private repository 30 by comparing the value of the media file attribute 26-1 to the value of the tag attribute 36-1, comparing the value of the media file attribute 26-2 to the value of the tag attribute 36-2, and so on. This attribute-for-attribute comparison may be carried out for every TP 32 in the private repository 30, or for just a subset of them.

Processing continues with determining similarities between the MP 22 and the TPs 42 in the public repository 40, to obtain the second set of suggested tags (Block 126). That is, the second set of suggested tags includes those tags 43 identified from the public repository 40, based on similarity determinations for the MP 22 with regard to the TPs 42. The attribute-for-attribute determinations are computed like that described above for the similarity determinations carried out with respect to the private repository 30. Those skilled in the art will appreciate that the tag server 12 can perform the similarity determinations with respect to the public repository 40, while the user device 10 can perform the similarity determinations with respect to the private repository 30. Alternatively, the tag server 12 may store or otherwise have access to both repositories, and carry out the similarity determinations for the private and public repositories 30 and 40. Still further, in at least some configurations, the user device 10 has access to the public repository 40 on a basis that allows it to perform the similarity determinations with respect to the public repository 40, in addition to doing so for the private repository 30.

With the first and second set of suggested annotation tags thus obtained, processing continues with forming the combined set of suggested annotation tags (Block 128), and outputting the combined set of suggested annotation tags (Block 130). To the extent that FIG. 5 is viewed as representing tag server processing, this outputting step can be understood as directly or indirectly sending the combined set of suggested annotation tags to the user device 10. To the extent that FIG. 5 is viewed as representing user device processing, the outputting step can be understood as outputting the combined set of suggested annotation tags to the user, e.g., via a display screen or other user interface element of the user device 10.

Processing then continues with identifying the selected tags (Block 132), which are the annotation tags from the combined set of suggested annotation tags that are selected by the user for annotating the media file 20. To the extent that FIG. 5 is viewed as representing tag server processing, this identifying step can be understood as directly or indirectly receiving information from the user device 10 indicating which tags the user selected. To the extent that FIG. 5 is viewed as representing user device processing, the identifying step can be understood as detecting, e.g., from user input (button presses, touch screen inputs, etc.) directed to the UI 66 of the user device 10, which tags the user selected for annotating the media file 20.

Indeed, a number of subsequent processing operations may flow from the identification of the suggested tags selected by the user for annotating the media file 20. For example, media file annotation may be carried out, where the tags are appended to the media file 20, or stored in a database or other data structure in a manner that links them to the media file 20. Further processing may include updating the private repository 30 (e.g., adapting the tag attribute weights 38, as needed, for the tags 33 that were among the selected tags and/or updating the media type weights 58 in the user profile 50). Still further, processing may include updating the public repository 40 (e.g., adapting the tag attribute weights 48, as needed, for the tags 43 that were among the selected tags). When updating the public repository 40 based on an individual user□ s selection of given tags 43 from the combined set of suggested tags, the weight adjustment may be small (as compared to adjusting weights 38 in the private repository 30 of that user), because it is the overall or aggregate preferences of the user community that are being embodied in the weight adaptations done for the public repository 40.

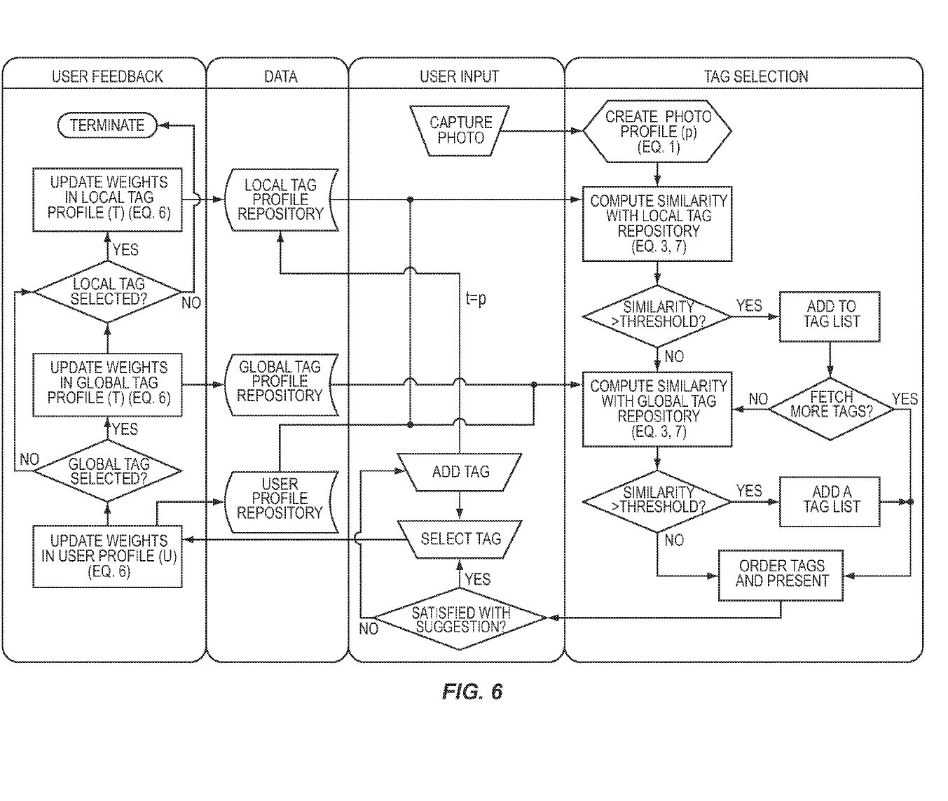

Turning to FIG. 6, one sees a more detailed logic flow diagram that provides one example of the □ process workflow□ carried out by a processing system for generating annotation tag suggestions in accordance with the method 100 introduced in FIG. 1. (Here, the contemplated □ system□ may include the user device 10, the tag server 12, or both.) The process workflow diagram uses a photograph as an example media file 20, but it could be any other multimedia type such as music or video.

After the photograph is captured, the system creates a corresponding MP 22, which includes contextual metadata for the photograph, as represented by the different values stored in various ones of the media file attributes 26. Broadly, tags 33 are suggested from the private repository 30 (denoted as a local tag repository in the diagram) and/or from the public repository 40 (denoted as a global tag repository in the diagram), in dependence on the similarity between metadata values carried in the media file attributes 26 and the metadata values carried in the tag attributes 36 for each tag 33 in the private repository 30 and/or the metadata values carried in the tag attributes 46 for each tag 43 in the public repository 40.

For example, to determine whether to include individual ones of the tags 33 from the private repository 30 in the combined set of suggested tags, the processing may include comparing the computed similarities (as dependent on Equations 3 and 7 detailed below) to a similarity threshold, which may be a predefined numeric threshold. Tags 33 having a sufficiently high similarity between their associated tag attributes 36 and the media file attributes 26 are included in a list of tags to be suggested to the user, and the remaining tags 33 in the private repository are excluded from the list. The same processing is carried out, but with respect to the tags 43 in the public repository 40.

Once the combined set of suggested tags is formed in this manner, it is presented to the user (e.g., displayed on the user device 10). Note, too, that in at least one embodiment, the listing of suggested tags is ordered according to the similarity determinations and/or other factors, such as tag □ popularity,□ which reflects how frequently the user (or the community of users) selects a given tag. Also, note that, if the user is not satisfied with the suggested tags, he or she may add custom tags to the list and/or modify one or more of the suggested tags□ these changes can be saved back to the private repository 30, or to the public repository 40.

With the suggested tags displayed for selection by the user, for annotating the given media file 20, processing continues as a function of the tag selections made by the user. That is, in response to the user selecting a given one of the suggested tags, the system updates the private repository 30 and/or the public repository 40, such as by updating weights corresponding to the tag attributes 36 or weights corresponding to the tag attributes 46 in dependence on the determined similarities with respect to the media file attributes 26. Such updating improves the □ intelligence□ underlying future tag suggestions.

More specifically, the tag 33 in each TP 32 within the private repository 30 has a weight vector (set 37) of tag attribute weights 38, which correspond to the attribute vector (set 34) of tag attributes 36, e.g., for a given tag 33, the associated weight 38-1 weights the tag attribute 36-1 for that given tag. The same is true for the attribute vectors (set 44) of tag attributes 46 and attribute weighting vectors (set 47) of attribute weights 48, which are stored in the public repository 40. As a non-limiting example, a place-name tag 43, such as □ Paris□ may have its location attribute 46-x set to lat./long. value(s) appropriate for Paris, France, and its other attributes 46 set to NA (not applicable), or, equivalently, the weights 38 for those other attributes 46 can be set to zero, so that they are effectively ignored in the similarity determinations. Similar attribute weighting schemes can be used for a □ face□ tag 43 (or a face tag 33), which may have only one important attribute 46 or 36, e.g., a Boolean value indicating whether a face was or was not detected in the photograph.

As for selecting tags for suggestion to a user, for use in tagging a given media file 20, both the media file 20 and a given tag 33 or 43 are represented by their attributes. Still assuming that the media file 20 is a photograph, the photo and each tag will be referred to as a photo instance and a tag instance. The photo and tag instances are represented by their respective attributes as:

p=[att₁,att₂, . . . ,attₙ] (1)

t=[att₁,att₂, . . . ,attₙ] (2)

Accordingly, an advantageous definition for determining (computing) the similarity between two instances (pictures or tags) is

$$sim ( {I}_{1} , {I}_{2} ) = \frac{{\sum }_{k = 0}^{n} {w}_{k} \cdot sim ( {att}_{k} ( {I}_{1} ) , {att}_{k} ( {I}_{2} ) , ont )}{{\sum }_{k = 0}^{n} {w}_{k}} \qquad ( 3 )$$

where ont is an ontology on the attribute level that defines a similarity metric between attributes, e.g., between an attribute 26-x and an attribute 36-x for a given tag 33 or 46-x for a given tag 43, where □ x□ simply denotes given attributes of the same metadata type.

The similarity between the different attributes can be computed as follows depending on the value of the attribute:
similarity between numbers: normalized distance between 0 and 1 (or an equivalent similarity);
similarity between binary values: 1 if they are equal, 0 otherwise (or an equivalent similarity);
similarity between terms and lists: number of steps that are required to transform the first element in the second, or vice versa, given a set of operations like insert, delete, etc.; or
similarity between hierarchical lists: number of steps that are similar from root.

Further, the associated set 37 of attribute weights 38 (for a set 34 of attributes 36 for a given tag 33) or set 47 of attribute weights 48 (for a set 44 of attributes 46 for a given tag 43) are normalized and will reflect the importance of each attribute with respect to the tag. Further, one may define the set 57 of metadata type weights 58 in the user profile 50 as

U=[w₁,w₂, . . . , wₙ], (4)

and any given set 34 of tag attributes 36 (or set 44 of tag attributes 46) as

T=[w₁,w₂, . . . ,wₙ]. (5)

Using the above definitions, when a user selects a tag t for a photo p the distance sim(t, p) will be computed. (The tag t may be any one of the tags 33 stored in the private repository 30, or the tag t may be any one of the tags 43 stored in the public repository 40.) The distance between each attribute sim(attₖ (t),attₖ (p),ont) will be used to update both the user profile U (user profile 50) and the tag profile T (any one of the TPs 32 or TPs 42).

If sim(attₖ (t),attₖ (p),ont) is large, then that indicates two things:
the user has a preference for tags where the similarity between attribute attₖ is large; thus wₖ in the user-profile U will be updated and increased; and
the tag chosen is relevant for that attribute attₖ since the similarity is large; thus wₖ in the tag-profile T will be updated and increased.

On the other hand, if sim(attₖ (t),attₖ (p),ont) on the other hand is small, then that indicates two things:
the user does not care whether the tags have a similar attribute attₖ; thus wₖ in the user profile U will be updated and decreased; and
the tag chosen is irrelevant for that attribute; thus wₖ in the tag-profile T will be updated and decreased.

The updating of the weight wₖ in the above examples can be computed by using a running average (another alternative could be to use median in order to counteract for outliers),

$${w}_{k} ( t + 1 ) = \frac{{w}_{k} ( t ) \cdot n + v}{n + 1} \qquad ( 6 )$$

where v is the current observation. By using this feedback to the system, the user profile 50 will adjust to what tags 33 or 43 the user prefers. Correspondingly, the implicated TPs 32 (or TPs 42) will adjust to what attributes 36 (or 46) are most important for describing those tags 33 (or 43).

When the similarity between a new photo or other media file 20 and the existing tags are computed, both the tag profile and the user profile will be taken into consideration by weighting together both weights

wₖ=aT(wₖ)+bU(wₖ) (7)

where a+b=1. In order to avoid biased cold start tags, the weight computed above can be adjusted by

$${w}_{k} = \frac{γ \cdot {w}_{def} + m \cdot {w}_{k}}{γ + m} , \qquad ( 8 )$$

where γ is a threshold number, e.g., 1000, w_{def} is the initial default rating, in is the number of times the specific tag has been chosen, and wₖ is the actual weight from Equation (7).

The fact that tags are personal is also taken into consideration by the system contemplated herein. The personal tags 33 are preferably stored in a local tag repository (the private repository 30) that is easily accessed by the user device 10. All the tags 43 in the global tag repository (the public repository 40) are weighted by Equation (8), which means that all the tags that are seldom used are adapted to have smaller weights, while more popular tags develop higher weights.

When selecting a tag for an image, the similarities between the image vector (the set 24 of media file attributes 26) and the user and tag vectors (the set 57 of metadata type weights 58 and the set 34 (or 44) of tag attributes 36 (or 46) for given tags 33 (or 43)) are computed as described in Equation (7). This similarity is, as mentioned in Equation (3), done at attribute level. Equation (3) also takes an ontology as an input parameter. One example when this could be useful is for dealing with languages. Two users living very close to each other geographically (each side of a country border), but in two different countries, will most likely speak different languages. Two persons can however live quite far from each other geographically but still be in the same country and speak the same language. By using an ontology it is possible to compute the similarity on a hierarchical level, e.g., same street but not same city, same country but not same continent, etc. Putting a high weighting value in the weight 58 in the user profile 50 for the type of metadata associated with such an attribute will favor tags using the user□ s “local” language, where local can mean anything from street to country.

For example, assuming that the user device 10 captures a picture of the Eiffel tower in Paris, and generates or obtains corresponding metadata information such as time=12:00:18, location=25.0955, 55.342083, object detection=□ river, building, park, face,□ and face recognition=□ girlfriend □ Anna□ .□ This information is used to set the values of the corresponding media file attributes 26 of the MP 22. The set 24 of the media file attributes 26 can then be compared as an image vector to the tag vectors of one or more tags 33 in the private repository 30 and/or one or more tags 43 in the public repository 40. (Here, the tag vector of each tag 33 or 43 is the set 34 or 44 of tag attributes 36 or 46.) For example, there may be an □ Eiffel Tower□tag in one of the repositories, whose location attribute yields a perfect or near perfect match to the location attribute in the MP 22. On the other hand, the location attribute values in the other tags would not match very well, or not at all. The Eiffel Tower tag would therefore be a strong candidate for suggesting to the user, based on the similarity between its location attribute and the location attribute of the MP 22.

Of course, there may be other tags, such as □ Paris,□ or □ Vacation in Paris□ that are included in the private or public repository 30 or 40. These tags also may have good matches in terms of their location attributes, with respect to the location attribute in MP 22. Further, they may have other attributes that match well with other attributes in the MP 22. For example, the □ Vacation in Paris□ tag may include a □ happy face□ attribute, which may match well with th detection of a smiling face in the photo. Further, the □ Vacation in Paris□ tag may be a very popular tag in the public repository 40, so it may be ranked very high in the listing of suggested tags to be presented to the user. There also may be personal tags in the private repository 30 which match very well to the MP 22, as regards one or more attributes. For example, the tag □ □ Anna in front of the Eiffel tower□ would include a metadata attribute (or attributes) the value(s) of which is (are) set based on recognizing Anna in a photographic image file (via image processing algorithms), and would further include at least location attributes, the values of which are set to the geographic location of the Eiffel Tower.

As described above, the suitability of a suggesting a given tag to a user depends on the degree of similarity between the metadata values associated with that tag and the metadata values of the media file 20 for which annotation tag suggestions are desired. To compute these similarities, the system contemplated herein uses a similarity function for evaluating each pair of attributes to be compared. The function takes as its input two attribute values of the same type□ i.e., an attribute 26-x from the MP 22 of the media file 20 and an attribute 36-y or 46-z of the same type (where □ x,□ □ y,□ and □ z□ denote given attributes (of like metadata sets 24, 34, and 44 of attributes 26, 36, and 46, respectively). The function returns a normalized value [0,1], reflecting the similarity of the two attributes being evaluated, where 1=maximal similarity and 0=no similarity.

For example, a similarity function sim can take string-type attributes as an input. The functional operation sim(camera1, camera2) compares two camera models by classifying them in three categories: system camera, compact camera and mobile camera. The function can be supported by an ontology that contains all relations between camera models and their camera categories. (In this context, an ontology denotes a taxonomy with a set of inference rules.) In more detail:

Individual(a:nikon_d70 type(a:System Camera))

Individual(a:canon_{—}20d type(a:SystemCamera))

Individual(a:canon_ixus type(a:Compact Camera)).

The sophistication may be further extended by defining symmetric properties such as verySimilar, similar, notAtAllSimilar and then writing swrl (Semantic Web Rule Language) rules like:

SystemCamera(?x) ̂ SystemCamera(?y)->verySimilar(?x, ?y)

SystemCamera(?x) ̂ CompactCamera(?y)->similar(?x, ?y)

SystemCamera(?x) ̂ CameraPhone(?y)->notAtAllSimilar(?x, ?y).

Similarity processing in view of the examples would yield:

verySimilar(nikon_d70, canon 20d)

similar(canon_{—}20d, canon_ixus)

and

verySimilar(canon_{—}20d, nikon_d70)

similar(canon_ixus, canon_{—}20d)

due to the symmetric property.

As another example, the similarity determination may involve geographic locations. Such a comparison involves the calculation of spherical trigonometry because of the curvature of Earth. Again, the contemplated system can make use of ontologies describing political regions to conclude, for example, that a city in Sweden close to the Norwegian border is more similar to another Swedish city than a Norwegian city that might be located closer geographically. In more detail:
Individual(a:Sweden type(a:country))
Individual(a:Norway type(a:country))
ObjectProperty(a:has_ParentRegion domain(a:City) range(a:Country))
Individual(a:arvika type(a:City) value(a:has_ParentRegion a:Sweden))
Individual(a:oslo type(a:City) value(a:has_ParentRegion a:Norway)).

Further, the system may use a rule to define similarities between cities:
hasParentRegion(?x, ?parent) ̂ hasParentRegion(?y, ?parent)->verySimilar(?x, ?y).

For the example immediately above, this rule yields:

verySimilar(arvika, stockholm)

similar(arvika, oslo)

where one sees that the degree of similarity has been determined to be higher between Arvika and Stockholm, although they are further apart than Arvika and Oslo.

As a further point of sophistication, one or more embodiments of the processing contemplated herein is configured to avoid the problem of noise caused, for example, by users adding very personal/subjective tags or misleading tags. To combat these types of noise, the system may cluster tags based on their frequency of selection by the community of users.

Tag clustering in the tag server 12, for example, is the process of grouping tags for media files 20 that are similar in some sense. The tag server 12 does so because it needs to know the importance of each tag among the community of users. The importance of each tag controls its position in the list of tags offered as suggestions for tagging new media files 20. For example, a user takes a new photo in a situation never experienced by the system (outside the user□ s personal tag space). The system will use information from the tag server 12 to tag the new photo, where the tag server 12 advantageously has a potentially large number of tags and associated attribute vectors. Among these attribute vectors there are some that are □ relevant□ to the photo under consideration. So, the system in theory should show these relevant tags first to the user.

More particularly, however, at least some of the <tags, attributes> describe, in essence, similar objects. For example, if a photo was taken on the same location where there are another ten photos already annotated with the same tag, then these related <tags, attributes> entities are grouped together as if they are one clustered object. Clustering allows the tag server 12 (and/or the user device 10) to estimate or otherwise track the selection frequency of individual tags, so that the most frequently selected tags are suggested first, or at least suggested in a manner that ranks them higher.

To achieve such clustering, the tag server 12 can, for example, aggregate input from various users in the form of a quadruplet <ui, tk, ak, wk> where ui is the i-th user, tₖ is the k-th tag and aₖ and wₖ are the attribute and weight vector corresponding to the tₖ. The tags tₖ over all the users are lexicographically clustered (it is assumed that the tags have been spelled correctly). Clustering will bring together tags that are spelled similarly but have different meanings. This operation can be understood as a form of word sense disambiguation (WSD) processing. The resulting clusters will be then split into thematically disjointed categories using the weight vectors wₖ associated with the tags. For example the word □ Paris□ can be attributed to both <Paris, town; France> and <Paris, person; Paris Hilton> (clear sign of homonym). The Euclidean distance between the weight vectors is used to partition the resulted clusters and hence achieve WSD. As a specific example, the tag server 12 applies such clustering processing to the tags 43 contained within the public repository 40.

In a further aspect of tag suggestion processing, the use of commercial tags is contemplated. (They may be included in the public repository 40, or included in their own repository having a similar data structure.) As might be expected, commercial enterprises want their tags to be suggested to users under appropriate circumstances, to foster brand recognition and, ultimately increase the consumption of their goods or services. Thus, one or more embodiments of the system contemplated herein maintains commercial tags. These tags may have associated with them tag attributes and attribute weights, much like those associated with the tags 43 in the public repository 40.

However, one difference is that commercial entities provide the following <cₜ, tₖ, aₖ, wₖ> where cₜ is the t-th commercial entity, tₖ corresponds to the tag (for example Harrods; London), aₖ is the attribute vector with only two non-zero elements, e.g., a location value (51°29′58.51″N 00°09′48.66″W) and wk is the corresponding weight vector. As an example, it may be desired to have the tag □ Ericsson Globe□ automatically suggested to users that take photos in or around the Ericsson Globe concert hall. In this case, the wireless network operator (or the tag server proprietor, if a different entity) charges to include the appropriate quadruplet within the commercial tag database. Further, a base fee may be charged for inclusion with a given weighting value or suggestion ranking, and additional fees may be charged to increase the frequency at which the tag is suggested, or to move it upward within any listing of suggested tags. As an example, the tag server 12 or an associated computer system provides secure login and tag purchasing screens accessible to authorized users via, e.g., a web browser interface. In this manner, commercial entities can electronically purchase and promote their tags within the public repository 40 or within a dedicated commercial tag repository that is accessible to the tag server 12.

However, the system contemplated herein provides a number of advantages, with or without the use of commercial tags. For example, sharing tags associated with multimedia attributes provides □ free□ annotated ground truths that can be used to re-estimate the tag classifiers, which results in a system with better classification performance. Further, the separation of tags into private and public repositories, and the weighting of tag suggestions based on the learned selection behaviors of the individual user and the community of users, provides for a unique fusing of tag suggestions based on individual and group behaviors and preferences. Further, the use of similarity determinations for each type of (metadata) attribute at issue makes the system both very flexible and accurate, while the use of Equation (8), for example, prevents malicious data and outliers from producing biased tag recommendations. Finally, the sharing of metadata and tags as taught herein need not expose the individual photos of a user, and the system thereby preserves the user□ s privacy, while giving the user access to tagging suggestions based on his or her own learned preferences, in combination with the learned preferences of a potentially large community of users.

1-23. (canceled)

24. A method of electronically generating suggested tags, for use by a user in annotating a media file, the method comprising:
obtaining a combined set of suggested tags that includes a first set of suggested tags obtained from an electronically stored private repository of tags specific to the user and a second set of suggested tags obtained from an electronically stored public repository of tags shared by a community of users;
outputting the combined set of suggested tags for presentation to the user via an electronic user device being used by the user for tagging the media file; and
identifying selected tags from among the suggested tags, as selected by the user for tagging the media file;
wherein the first set of suggested tags is obtained based on determined similarities between media file attributes associated with the media file and corresponding tag attributes associated with individual ones of the tags in the private repository;
wherein the second set of suggested tags is obtained from the public repository based on determined similarities between media file attributes associated with the media file and corresponding tag attributes associated with individual ones of the tags; and
wherein any given media file attribute or tag attribute comprises a value for a defined type of contextual metadata, such that a degree of similarity can be determined between any given media file attribute and any given tag attribute having the same defined type of contextual metadata.

25. The method of claim 24, wherein obtaining the combined set of annotation tags comprises the user device obtaining the first set of suggested tags from the private repository as electronically stored within the user device, obtaining the second set of suggested tags by sending the media file attributes to a remote network node and receiving the second set of suggested tags in return, and combining the first and second sets of suggested tags.

26. The method of claim 25, further comprising sending user preferences from the user device to the remote network node, along with sending the media file attributes, to bias the similarity determinations made by the remote network node between the media file attributes and the corresponding tag attributes stored for individual tags in the public repository.

27. The method of claim 24:
further comprising performing the method in a network node remote from the user device being used by the user for tagging the media file;
wherein the method further comprises storing the public and private repositories in electronic storage accessible to the network node;
wherein obtaining the combined set of suggested tags comprises receiving the media file attributes from the user device, generating the first and second sets of suggested tags, and forming the combined set of suggested tags; and
wherein outputting the combined set of suggested tags comprises sending the combined set of suggested tags to the user device.

28. The method of claim 24:
further comprising weighting the similarity determinations made with respect to the private repository according to user preferences specific to the user, the user preferences learned based on past selections of suggested tags made by the user; and
wherein the similarity determinations made with respect to the public repository are weighted according to community preferences global to the community of users, the community preferences learned based on past selections of suggested tags made by users within the community of users.

29. The method of claim 28:
wherein the user preferences comprise a set of tag attribute weights corresponding to the tag attributes associated with each tag stored in the private repository;
wherein the user preferences further comprise a user profile comprising a set of metadata type weights corresponding to different types among the defined types of contextual metadata: and
wherein the method further comprises:
adapting the tag attribute weights for a given tag in the private repository each time the user selects that tag for tagging any given media file, based on the similarity of values between each tag attribute and the corresponding media file attribute of the given media file, so that the tag attribute weights over time reflect a relative importance attached by the user to each tag attribute of that tag; and
adapting the user profile for the tags selected by the user for tagging any given media file, based on the similarity of values between the media file attributes and the values of the corresponding tag attributes of the selected tags, so that the user profile over time reflects a relative importance attached by the user to the different types of contextual metadata.

30. The method of claim 29, further comprising using the user profile to bias the weighting of the similarity determinations made with respect to the public repository.

31. The method of claim 24, further comprising:
maintaining the private repository as a set of tag profiles where each tag profile comprises a tag for annotating media files, a set of tag attributes where each attribute comprises a value for one of the defined types of contextual metadata, and a set of tag attribute weights corresponding to the tag attributes; and
updating each tag attribute weight whenever the user selects the corresponding tag for tagging a given media file based on computing the degree of similarity between the value of the associated tag attribute and the corresponding media file attribute of the media file being tagged.

32. The method of claim 31, further comprising:
maintaining a user profile of metadata type weights, each metadata type weight comprising a value for one of the defined types of contextual metadata; and
updating a given metadata type weight in the user profile whenever the user selects a suggested tag having a tag attribute of the same type based on computing the degree of similarity between the value of the tag attribute and the corresponding media file attribute of the media file being tagged.

33. The method of claim 24, further comprising:
maintaining the public repository as a set of tag profiles where each tag profile comprises a tag for annotating media files, a set of tag attributes where each attribute comprises a value for one of the defined types of contextual metadata, and a set of tag attribute weights corresponding to the tag attributes; and
updating each tag attribute weight whenever any given user in the community of users selects the corresponding tag for tagging a given media file based on computing the degree of similarity between the value of the associated tag attribute and the corresponding media file attribute of the media file being tagged.

34. The method of claim 33, further comprising:
maintaining a commercial tag repository along with or within the public tag repository for use in suggesting commercial tags to the community of users: and
setting tag attribute weights for a given one of the commercial tags according to a monetary value of the commercial tag.

35. The method of claim 24, further comprising:
generating the first set of suggested tags according to selection weights specifically adapted based on suggested tag selections made by the user; and
generating the second set of suggested tags according to selection weights adapted according to suggested tag selections made by given ones in the community of users.

36. An apparatus configured for automatically suggesting tags to a user, for annotating a media file, the apparatus comprising one or more digital processing circuits configured to:
obtain a combined set of suggested tags that includes a first set of suggested tags taken from an electronically stored private repository of tags that is specific to the user and a second set of suggested tags taken from an electronically stored public repository of tags that is shared by a community of users;
output the combined set of suggested tags for presentation to the user via an electronic user device being used by the user for tagging the media file; and
identify selected tags from among the suggested tags, as selected by the user for tagging the media file;
wherein the first set of suggested tags is based on determined similarities between media file attributes associated with the media file and corresponding tag attributes associated with individual ones of the tags in the private repository;
wherein the second set of suggested tags is obtained from the public repository based on determined similarities between media file attributes associated with the media file and corresponding tag attributes associated with individual ones of the tags;
wherein any given media file attribute or tag attribute comprises a value for a defined type of contextual metadata, such that a degree of similarity can be determined between any given media file attribute and any given tag attribute having the same defined type of contextual metadata.

37. The apparatus of claim 36, wherein the apparatus comprises the user device, and wherein the user device includes:
memory operatively associated with the one or more digital processing circuits and configured to store the private repository; and
a communication circuit operatively associated with the one or more digital processing circuits and configured to communicatively couple the user device to a remote network node storing the public repository;
wherein the communication circuit is configured to obtain the second set of suggested tags by sending the media file attributes to the remote network node and receiving the second set of suggested tags in return.

38. The apparatus of claim 37:
wherein the memory of the user device is further configured to store user preferences for tag selection; and
wherein the communication circuit is configured to send the user preferences to the remote network node along with the media file attributes to bias the similarity determinations made by the remote network node between the media file attributes and the corresponding tag attributes stored for individual tags in the public repository.

39. The apparatus of claim 36, wherein the apparatus comprises a network node communicatively coupled directly or indirectly to the user device, and wherein the network node is configured to:
access electronic storage storing the public and private repositories;
receive the media file attributes from the user device;
form the combined set of suggested tags by the determined similarities with respect to the private and public repositories; and
output the combined set of suggested tags by sending them to the user device.

40. The apparatus of claim 36:
wherein the one or more digital processing circuits are further configured to weight the similarity determinations made with respect to the private repository according to user preferences specific to the user, the user preferences learned based on past selections of suggested tags made by the user; and
wherein the similarity determinations made with respect to the public repository are weighted according to community preferences global to the community of users, the community preferences learned based on past selections of suggested tags made by users within the community of users.

41. The apparatus of claim 40:
wherein the user preferences comprise a set of tag attribute weights corresponding to the tag attributes associated with each tag stored in the private repository;
wherein the user preferences comprise a user profile comprising a set of metadata type weights corresponding to different types among the defined types of contextual metadata; and
wherein the one or more digital processing circuits are further configured to:
adapt the tag attribute weights for a given tag in the private repository each time the user selects that tag for tagging any given media file based on computing the similarity of values between each tag attribute and the corresponding media file attribute of the given media file, so that the tag attribute weights over time reflect a relative importance attached by the user to each tag attribute of that tag; and
adapt the user profile for the tags selected by the user for tagging any given media file based on computing the similarity of values between the media file attributes and the values of the corresponding tag attributes of the selected tags, so that the user profile over time reflects a relative importance attached by the user to the different types of contextual metadata.

42. The apparatus of claim 41, wherein the one or more digital processing circuits are further configured to use or otherwise provide the user profile for biasing the weighting of the similarity determinations made with respect to the public repository.

43. The apparatus of claim 36:
wherein the private repository is stored as a set of tag profiles where each tag profile comprising a tag for annotating media files, a set of tag attributes where each attribute comprising a value for one of the defined types of contextual metadata, and a set of tag attribute weights corresponding to the tag attributes; and
wherein the one or more digital processing circuits are further configured to update each tag attribute weight whenever the user selects the corresponding tag for tagging a given media file based on computing the degree of similarity between the value of the associated tag attribute and the corresponding media file attribute of the media file being tagged.

44. The apparatus of claim 43:
wherein a stored user profile includes metadata type weights, each metadata type weight comprising a value for one of the defined types of contextual metadata; and
wherein the one or more digital processing circuits are further configured to update a given metadata type weight in the user profile whenever the user selects a suggested tag having a tag attribute of the same type based on computing the degree of similarity between the value of the tag attribute and the corresponding media file attribute of the media file being tagged.

45. The apparatus of claim 36:
wherein the public repository is stored as a set of tag profiles where each tag profile comprising a tag for annotating media files, a set of tag attributes where each attribute being a value for one of the defined types of contextual metadata, and a set of tag attribute weights corresponding to the tag attributes; and
wherein the one or more digital processing circuits are further configured to update each tag attribute weight whenever any given user in the community of users selects the corresponding tag for tagging a given media file based on computing the degree of similarity between the value of the associated tag attribute and the corresponding media file attribute of the media file being tagged.

46. The apparatus of claim 45:
wherein a stored commercial tag repository is included in or is accessible with the public tag repository; and
wherein the one or more digital processing circuits are further configured to use the commercial tag repository for suggesting commercial tags to the community of users, wherein tag attribute weights for a given one of the commercial tags are set according to a monetary value of the commercial tag.
